(19) United States
(12) Patent Application Publication
(10) Pub. No.: US 2010/0166623 A1
(43) Pub. Date: Jul. 1, 2010

(54) DEVICE FOR THE THERMAL DEHALOGENATION OF HALOGEN-CONTAINING SUBSTANCES

(75) Inventors: Andreas Hornung, Karlsruhe (DE); Helmut Seifert, Ludwigshafen (DE); Wolfgang Koch, Eggenstein (DE)

Correspondence Address: LEYDIG, VOIT AND MAYER, TWO PRUDENTIAL PLAZA, SUITE 4900, 180 NORTH STETSON AVENUE, CHICAGO, IL, 60601, US

(73) Assignee: Forschungszentrum Karlsruhe GmbH, Karlsruhe (DE)

(21) Appl. No.: 12/294,902

(22) PCT Filed: Dec. 8, 2006
(86) PCT No.: PCT/EP2006/011797

§ 371 Date: Sep. 26, 2008

(30) Foreign Application Priority Data
Mar. 29, 2006 (DE) 10 2006 014 457.0

(51) Int. Cl. B01J 19/00

(52) U.S. Cl. 422/198

(57) ABSTRACT

A device for thermal dehalogenation of halogen-containing substances. The device includes a temperable reaction volume. The temperable reaction volume includes a top vapor space, a bottom sump region, a first inlet for a halogen-containing substance, a second inlet for a polyolefin, a first outlet for dehalogenated substances and halogen-containing reaction products, and a second outlet for the polyolefin. The second inlet includes a heater configured to heat the polyolefin to above a softening point thereof. The second inlet discharges into the top vapor space and includes at least one nozzle.

### CROSS REFERENCE TO RELATED APPLICATIONS

This application is a U.S. National Phase application under 35 U.S.C. §371 of International Application No. PCT/EP2006/011797, filed on Dec. 8, 2006 and claims benefit to German Patent Application No. DE 10 2006 014 457.0, filed on Mar. 29, 2006. The International Application was published in German on Oct. 11, 2007 as WO 2007/112776 A1 under PCT Article 21(2).

### FIELD

The present invention relates to a device for the dehalogenation, in particular debromination of halogen-containing, respectively bromine-containing substances, in particular of waste materials, as set forth in the first claim. The device is used, in particular, for the debromination of fluid substances, in particular of carbonaceous substances, such as oils, as well as for the liquefaction of polypropylene in the course of a thermal treatment in a reactor.

### BACKGROUND

The German Patent Application DE 102 34 837 A1 describes a process concept for treating halogen-containing, such as bromine-containing waste materials, by pyrolysis, where recyclable materials and/or energy are able to be recovered without producing any further halogenated contaminants. In this context, the waste materials are mixed in a first step in an inert gas with a molten polyolefin (substituted or unsubstituted) in an inert atmosphere. In a second step, the hydrogen halides formed during melting are separated off, the carbon- bromine bond splitting at temperatures above 270° C. without the use of a coreactant. The phenyl radicals are stabilized, for example, by radical recombination with another aromatic compound. However, this reaction path leads to the formation of biphenyl derivatives, to carbonization and, undesirably, to the formation of halogenated dibenzo-p-dioxins (PBDD) and dibenzo-p-furans (PBDF). The latter are able to be effectively suppressed in a pyrolysis process in the presence of polyolefins, such as polyethylene or polypropylene. The actual debromination is then effected by the attack of the phenyl- and bromine radicals on the macromolecules of the polyolefin under hydrogen abstraction. If one starts out from bromophenol and polypropylene, for example, then phenol and hydrogen bromide are obtained as main products. Alkyl phenols and alkyl bromides are formed as secondary products. Adding polyethylene or polypropylene allows stable molecules to be formed from the radicals, thereby also preventing PBDD and PBDF from forming.

The described method may ensure that organic substances, such as oils, can be debrominated, making them suited for further use as secondary fuel.

However, successfully implementing the aforementioned process concept necessitates a sufficient residence time to carry out the aforementioned, required chemical processes. An industrial-scale implementation under general commercial conditions fails because the residence time of the brominated organic vapors in the reactor (or waste stream through the reactor) that is comparatively short relative to the total treatment duration connotes only an incomplete conversion (dehalogenation or debromination). On the other hand, simply prolonging the residence time increases the process time in an installation and thus limits throughput and, consequently, profitability without creating additional capacity.

### SUMMARY

An aspect of the present invention is to provide a device for debrominating oils and for liquefying polypropylene that will enable organic substances to be debrominated on an industrial scale and that will not exhibit the aforementioned limitations. A further, alternative, aspect of the present invention is that the chemical reaction referred to in the context of the related art be able to be implemented within a treatment time that is considered suitable from a technical standpoint.

In an embodiment, the present invention provides for a device for thermal dehalogenation of halogen-containing substances. The device includes a temperable reaction volume. The temperable reaction volume includes a top vapor space, a bottom sump region, a first inlet for a halogen-containing substance, a second inlet for a polyolefin, a first outlet for dehalogenated substances and halogen-containing reaction products, and a second outlet for the polyolefin. The second inlet includes a heater configured to heat the polyolefin to above a softening point thereof. The second inlet discharges into the top vapor space and includes at least one nozzle.

### BRIEF DESCRIPTION OF THE DRAWINGS

The present invention is described in greater detail below on the basis of exemplary embodiments with reference to the drawings in which:

FIG. 1: a cross section of a specific embodiment having a reaction volume and inlets for polyolefin;

FIGS. 2a and b: alternative design options for the inlets for polyolefin;

FIG. 3: a schematic view of another specific embodiment having a spiral conveyor for polypropylene; as well as

FIG. 4: the characteristic time curves for concentrations of various bromine compounds in the case of a debromination.

### DETAILED DESCRIPTION

A commercial application potential of the present invention of dehalogenation resides, for example, in the disposal of brominated starting material, such as when converting mother liquors of prepared plastic fractions, in conjunction with a pyrolysis of electronic scrap, in the treatment of brominated oils, in the production of secondary fuels, as well as in the chemical recycling of polypropylene.

In the case of solid starting material, the liquefaction thereof to produce the aforementioned fluid substances, for example by pyrolysis, constitutes the preliminary stage. Suitable starting materials generally include all organic materials or components which contain organic materials that are contaminated with halogens, such as bromine, or that contain halogens or bromine.

One important feature of the present invention relates to the location and design of the inlet for introducing the polyolefins into the reaction volume. It has a heating device for heating the polyolefin to above the softening point in order to condition the same prior to injecting it into the reaction volume, it being possible for the heating device to be constituted of the aforementioned tempering device. In the temperature range of between approximately 200° C. and 500° C., for example, between approximately 300 and 400° C., polyolefin, such as polypropylene (softening point around 200° C., decomposition starting at or above approximately 350° C.) or polyethylene is in the softened conveyable and injectable state, i.e., within a viscosity range of between 10 and 70 Pas. The polyolefin can be input as a raw material, such as granular material, into a conveyor, such as a spiral conveyor or a melt pump, for example, and heated already therein, i.e., outside of the reaction volume, until a pumpable mass is obtained.

The device can include an activable/deactivable recycling option for the polyolefin (return flow and re-feeding), i.e., a fluid connection for the aforementioned polyolefin melt between the inlet and the outlet for the polyolefin in the reaction volume. Depending on the specific embodiment, the fluid connection can have a feed pump and/or a heating device.

The inlet can include at least one nozzle (including extruder assemblies), which can be oriented in the reaction volume toward the substances to be dehalogenated. In principle, the nozzles allow the polyolefins to be injected into the substances over a preferred large specific surface area, thereby advantageously accelerating the chemical processes taking place. A multiplicity of parallel-connected nozzles distributed within the reaction volume allow the polyolefin to be distributed over the entire volume of the substance to be dehalogenated, thereby significantly reducing the time required for a complete reaction over the entire volume of the substance. In principle, the chemical kinetics inherent in the reactions described in German Patent Application DE 102 34 837 A1 may be selectively controlled as a function of the positioning and orientation of the nozzles in the reaction volume.

The inlet for the polyolefin can discharge into the top vapor space which contains the substances to be dehalogenated in a molecular, thoroughly miscible form that is able to be contacted by the polyolefin. This ensures that the substances to be dehalogenated have chemical access to the polyolefin as a coreactant, ideally spontaneously and by all molecules. The substances are typically present as gases, vapors, liquids, or as dust or fine particles in the vapor space that is directly or indirectly tempered by the heating of the reaction volume. They may also form constituents of molten or liquid aerosols, atomizations or, in principle, also of suspensions.

To implement the aforementioned thermal treatment in the reaction volume, an inert gas atmosphere, such as a nitrogen atmosphere, for example, which is introduced via a gas supply inlet, should be established and maintained. The gas supply inlet may be realized either as a separate, supplementary feed pipe or as a gas supply inlet for a two-substance or multi-substance nozzle for introducing the polyolefin or components of the halogenated substance, the inert gas assuming the function of a carrier gas, for example for an atomization.

An embodiment includes a reaction system featuring a top feeding of a polyolefin melt, i.e., having a nozzle assembly at the top in the reaction volume and oriented downward therefrom into the vapor space. The polyolefin can be deposited from above onto the substances to be dehalogenated (by heating, for example in gaseous or vaporous form) and mixed in, a large specific polyolefin surface area being ensured by one nozzle, for example, by a multiplicity of individual nozzles of the nozzle assembly. The polyolefin can be discharged from the nozzles either as fine threads or as atomized molten aerosol. In the latter case, tempering should be employed to substantially lower the viscosity of the polyolefin to the point where atomization can be rendered possible without a significant pressure build-up in the conveying system. In the polypropylene (PP) example, a temperature range within the thermal decomposition range of PP (approximately 350° C.), of between approximately 300 and 400° C., for example of between 330 and/or 360° C., may be targeted.

The problem of reaction kinetics encountered in a dehalogenation process, i.e., the relatively slowly occurring reaction, may be a limiting factor. A proposed countermeasure provides for inverting the application of the reaction phases, as mentioned above. In this context, the polypropylene is present as a flow-through phase, while the halogenated substances, such as brominated oils, for example, are fed as liquid to be vaporized into the reaction volume. In a state characterized by a large specific surface area, the polypropylene can penetrate the circumambient substances to be halogenated. The greatest possible polypropylene melt surface area can be realized (polypropylene molten threads or droplets or mist) by feeding the polypropylene via one or a plurality of nozzles, atomizers or spinning heads, for example in the top region of the reactor, which melt surface area is able to react with the halogenated or brominated substances contained in the top vapor space in the reaction volume. In addition, the polymer melt entering into the sump region of the aforementioned substances located below the vapor space may be able to entrain a portion of the substances, such as oil, and then still cause the same to react in the melt phase (preferably in the sump region, but also in a polypropylene recycling circuit). Moreover, polypropylene melt may be drawn from the sump region and fed via a preferably heated connecting line and an inlet into the vapor space again, the entrained substances being recycled again into the vapor space and fed again to the dehalogenation process taking place there. The substances advantageously first exit the functioning device when they are dehalogenated. Also, pyrolysis products of the polyolefin passing over into the gas space enter into reaction with the halogenated or brominated products contained in the vapor space. To this end, the reactor can be designed to be pressure-resistant, thereby allowing potential reaction times to be prolonged and hindering the tendency of products to pass into the gas phase (Le Chatelier principle).

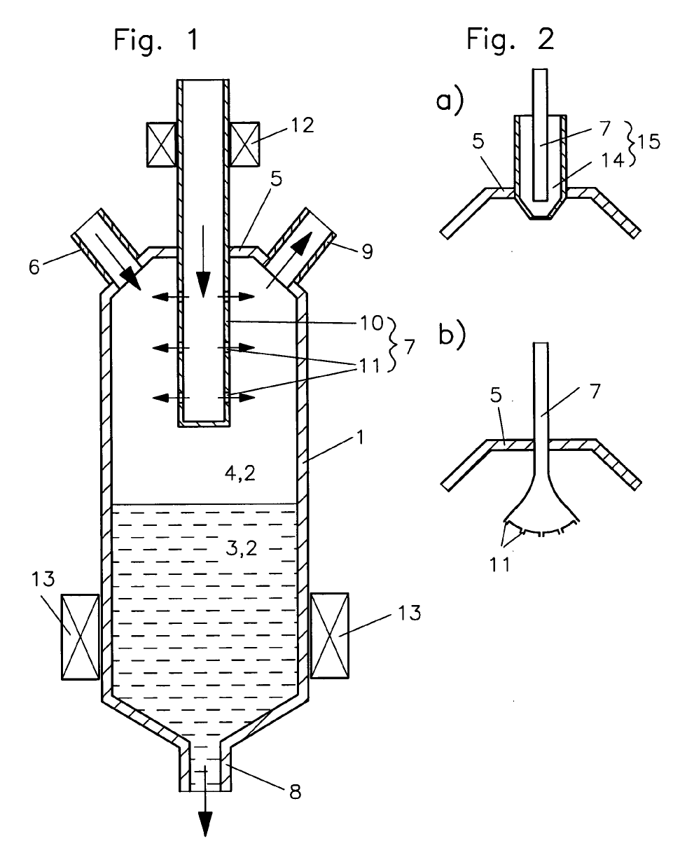

The embodiment shown in FIG. 1 includes a reactor 1 having a reaction volume 2 where the substances to be dehalogenated are located in a bottom sump region 3 underneath a vapor space 4 in top region 5. The reactor also has a substance inlet 6, a polyolefin inlet 7, outlets for polyolefin 8, as well as for the dehalogenated substances and gas products 9. The last-mentioned outlets for the dehalogenated substances and the gas products may be jointly or separately configured, in the case of a jointly configured outlet, the dehalogenated substances and the gas products (including halogen compounds) being separated in a downstream stage (not shown). The polyolefin feed pipe includes a nozzle tube 10 that is closed on one side and that features a multiplicity of radially outwardly oriented individual nozzles 11 on the peripheral surface. The polyolefin to be injected is pressed into the nozzle tube, already preheated by a continuous-flow heater 12 and issues as fine jets or mist through individual nozzles 11 into vapor space 4. The reactor has a tempering device 3 to heat reaction volume 2. Downpipe 8 may be designed as an extruder having a cutting-off device for a solidifying substance mixture containing the dehalogenated substances and polyolefin.

An agitator (not shown) or some other circulation device may be optionally provided in reaction volume 1 to further enhance the intermixing and thus accelerate the reaction.

The aforementioned agitator may also be designed and utilized as a polyolefin feed pipe, by locating the same for example on the stirring spoons, the position thereof constantly changing and advantageously accelerating an intermixing of the polyolefin with the substance mixture.

For an atomizer nozzle, FIG. 2a depicts exemplarily an alternative polyolefin inlet 7 in a sheath flow line 14 for an inert gas as a two-substance nozzle 15 for producing a polyolefin mist or an aerosol. On the other hand, for a multi-nozzle configuration for producing fine threads or droplets, FIG. 2b illustrates exemplarily a polyolefin feed pipe 7, which discharges into a multiplicity of individual nozzles 11 which spread apart in a three-dimensional fan-shaped configuration.

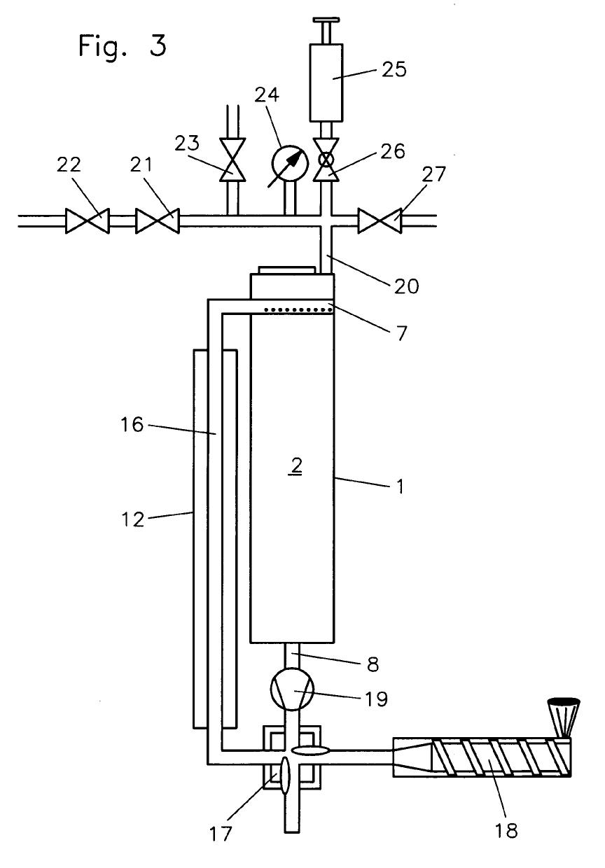

FIG. 3 shows an embodiment in a schematic system representation. Polyolefin inlet 7 is designed as a horizontal pipe that is closed on one side having a horizontal nozzle array of substantially identical individual nozzles (bores having 0.5 mm diameter) that is connected via a conveyor line 16 (connecting line) having a continuous-flow heater 12 to a preferably heatable distributor 17 (having a valve circuit). Distributor 17 has at least two switch positions, a first switch position (fresh feed position) allowing fresh polyolefin to be supplied from a spiral conveyor 18, and the second switch position (recycling switch position) allowing polyolefin drawn from reaction volume 2 to be fed into conveyor line 16. As a means of conveyance for a recycling process, a melt pump 19 is interposed between polyolefin outlet 8 and distributor 17. In the context of this embodiment, the substance inlet, as well as the outlet for dehalogenated substances and gas products are combined with an inlet for an inert gas atmosphere to form a reactor head-side connecting pipe 20, it being able to execute the specific tasks via various components. Since the embodiment is only conceived for batch operations, and thus does not necessitate a simultaneous charging and discharging of the dehalogenated substance, the aforementioned connecting pipe designed for a plurality of tasks does not adversely affect the ongoing operation, especially as an optionally provided polyolefin recycling circuit can be decoupled herefrom and is thus not affected. The mentioned components include, for example, a ball valve 21 having an electromechanical valve 22 including a safety valve 23 and pressure gauge 24 for supplying the inert gas atmosphere in the vapor space, a supply vessel 25 having an inlet valve 26 for a liquid substance or a halogenated substance that is liquefied by pyrolysis, for example, as well as an outlet valve 27 for the dehalogenated substances and reaction products present in the gas phase.

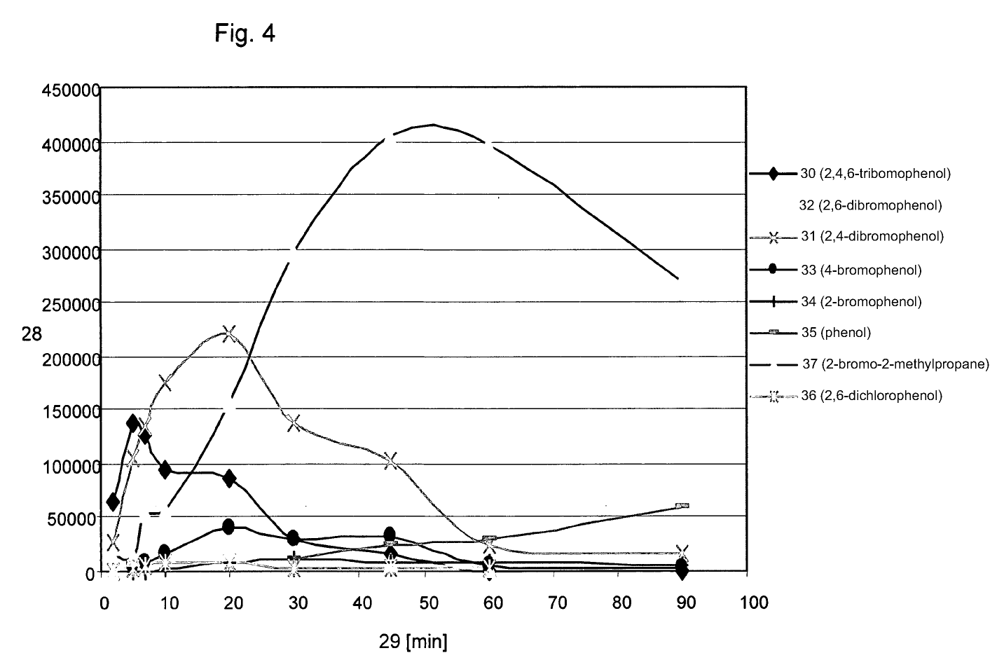

FIG. 4 shows the concentrations of various bromine compounds 28 (respectively, the measured characteristic signal-amplitude curve, i.e., not a specific unit) over characteristic test-time curve 29 in the case of a debromination of 3.5 g tribromophenol (TBP) in a reactor of a specific embodiment according to FIG. 3 where polypropylene is used as a coreactant. At point in time 0, the substances to be dehalogenated are introduced, resulting in an increase, in particular, of 2,4,6-tribromophenol 30 and 2,4-dibromophenol 31, while an increase of 2,6-dibromophenol 32, 4- and 2-bromophenol 33, respectively, 34, as well as of phenol 35 and 2,6-dichlorophenol 36, which are contained only in smaller concentrations, is much less pronounced. A spontaneous contact with a polypropylene molten aerosol as a coreactant occurs concurrently with a heating to approximately 350° C. in the reactor, a chemical conversion, in particular, of the aforementioned bromine compounds 30 to 34 to 2-bromo-2-methylpropane 37 occurring, which is then drawn off from the reaction volume via the connecting pipe. On the basis of the results illustrated in FIG. 4, a batch operation can be terminated within a time window of between 40 and 80 min, for example between 60 and 80 min (concentration of 2,4,6-tribromophenol 30 falls to a minimum value). REFERENCE NUMERAL LIST 1 reactor 2 reaction volume 3 sump region 4 vapor space 5 top region 6 substance inlet 7 polyolefin inlet 8 polyolefin outlet 9 outlet for dehalogenated substances and gas products 10 nozzle tube 11 individual nozzles 12 continuous-flow heater 13 tempering device 14 sheath flow line 15 two-substance nozzle 16 conveyor line 17 distributor 18 spiral conveyor 19 melt pump 20 connecting pipe 21 ball valve 22 valve 23 safety valve 24 pressure gauge 25 supply vessel 26 inlet valve 27 outlet valve 28 concentrations of various bromine compounds 29 characteristic test-time curve 30 2,4,6-tribromophenol 31 2,4-dibromophenol 32 2,6-dibromophenol 33 2-bromophenol 34 4-bromophenol 35 phenol 36 2,6-dichlorophenol 37 2-bromo-2-methylpropane

1-10. (canceled)

11. A device for thermal dehalogenation of halogen-containing substances, the device comprising a temperable reaction volume comprising:
a top vapor space;
a bottom sump region;
a first inlet for a halogen-containing substance;
a second inlet for a polyolefin, the second inlet including a heater configured to heat the polyolefin to above a softening point thereof, the second inlet discharging into the top vapor space and including at least one nozzle;
a first outlet for dehalogenated substances and halogen-containing reaction products; and
a second outlet for the polyolefin.

12. The device as recited in claim 11, wherein the bottom sump region is configured to discharge downward into the second outlet.

13. The device as recited in claim 11, further comprising a conveyor line connecting the second outlet with the second inlet and configured to recycle the polyolefin into the temperable reaction volume.

14. The device as recited in claim 11, wherein the halogen-containing substance exist in the top vapor space in at least one of a molecular and a miscible form that is able to be contacted by the polyolefin.

15. The device as recited in claim 14, wherein the form of the halogen-containing substance in the top vapor space is at least one of gaseous, aerosol, vaporous, liquid and powdery with particle sizes in the submicron range.

16. The device as recited in claim 11, wherein the at least one nozzle includes a plurality of nozzles.

17. The device as recited in claim 16, wherein the nozzles of the plurality of nozzles are distributed over the temperable reaction volume and configured to discharge thereinto.

18. The device as recited in claim 11, wherein the at least one nozzle includes an atomizing nozzle.

19. The device as recited in claim 18, wherein the atomizing nozzle is a two-substance atomizing nozzle for at least one of an inert gas, an oil-containing aerosol and the polyolefin.

20. The device as recited in claim 11, wherein the at least one nozzle is oriented vertically or horizontally and configured to discharge into the temperable reaction volume.
